(19) United States
(12) Patent Application Publication
(10) Pub. No.: US 2004/0131740 A1
(43) Pub. Date: Jul. 8, 2004

(54) Edible transfer tattoos

(76) Inventors: James F. Woodhouse, Killingworth (GB); Ellis Williams, Grindon (GB); John R. Russell, Bedlington (GB); Andrew M. Candler, Morpeth (GB); Fergal Keohane, Newcastle-upon-Tyne (IE)

Correspondence Address: FISH & RICHARDSON P.C., 3300 DAIN RAUSCHER PLAZA, 60 SOUTH SIXTH STREET, MINNEAPOLIS, MN, 55402, US

(21) Appl. No.: 10/723,593

(22) Filed: Nov. 26, 2003

(30) Foreign Application Priority Data
Nov. 27, 2002 (GB) 0227661.6
Apr. 10, 2003 (GB) 0308298.9
Oct. 21, 2003 (EP) 03256613.5

(51) Int. Cl. A21D 10/00

(52) U.S. Cl. 426/549

(57) ABSTRACT

Edible substrates, edible transfer tattoos, and methods for preparing the same are described. Edible substrates typically comprise a first starch component, a first emulsifer, a first thickening agent, and a lubricant. Other optional ingredients include a disintegrant, a colorant, a flavorant, a humectant, a plasticizer, sweeteners, acidity regulators, water, and additional starch components, emulsifiers, and thickening agents.

### CROSS-REFERENCE TO RELATED APPLICATIONS

This application claims the benefit under 35 U.S.C. § 119(a) of GB 0227661.6, filed Nov. 27, 2002; GB 0308298.9, filed Apr. 10, 2003; and EP 03256613.5, filed Oct. 21, 2003, the disclosures of which are herein incorporated by reference in their entirety.

### TECHNICAL FIELD

The invention relates to edible transfer tattoos, edible substrates for the preparation of edible transfer tattoos, and methods of manufacture of the same.

### BACKGROUND

Transfer tattoos usually comprise an image formed on a carrier (e.g., a paper-like carrier) and have been typically used as a means to adorn or to decorate a person's skin. The tattoo image can be transferred from the carrier to a receptor surface depending upon the nature of the transfer tattoo and the end use. A typical receptor surface is skin or a comestible product, e.g., a cookie or biscuit. Transfer tattoos can be used by a child as a plaything. A tattoo image can be transferred to a child's skin by wetting the skin and placing the transfer tattoo over the wetted area. The transfer tattoo is gently rubbed and, after a time sufficient to allow the design to transfer onto the skin, the paper carrier is peeled off to reveal the tattoo. The paper carrier can then be discarded. Unfortunately, the application of the tattoo typically piques the child's interest, while the proper disposal of the paper carrier is frequently ignored, thereby often resulting in improper disposal of the paper carrier.

### SUMMARY

The invention is based on the finding that edible transfer tattoos can be prepared from edible substrates. An edible substrate is typically formed into a sheet and includes one or more starch components. Use of an edible substrate allows a user to consume the substrate on which the transfer tattoo is printed rather than having to dispose of the substrate, as required for paper carriers.

Typically, a starch-based edible substrate includes a first starch component, a first thickening agent, a lubricant, and a first emulsifier. Additional components can include disintegrants, water, acidity regulators, additional starch components, additional thickening agents, additional emulsifiers, colorants (e.g., whitening and/or opacifying agents), preservatives, plasticizers, humectants, sweeteners, and flavorants. Methods for manufacturing edible substrates and edible transfer tattoos comprising edible substrates are also provided.

Accordingly, in one aspect, the invention provides an edible substrate. The edible substrate can be adapted for having an edible ink composition printed thereon, e.g., an edible transfer tattoo image. An edible substrate can be starch-based. An edible substrate can include: a) a first starch component; b) a first emulsifier; c) a first thickening agent; and e) a lubricant, wherein the edible substrate is adapted for having an edible ink composition printed thereon. The first starch component can be a modified starch. The first starch component can be present at from about 0.1% to about 6% by weight, or from about 0.1% to about 1% by weight. A first emulsifier can be present from about 0.1% to about 3.5% by weight, or from about 0.1% to about 2% by weight, and can be selected from the group consisting of polysorbate, polysorbate 60, Tween 60, glycerin, polyoxyethylene sorbitan monostearate, crillet, polyglycerol polyricinoleate, acetic esters of monoglycerides, and lecithin. A first emulsifier can be lecithin.

A first thickening agent can be present at from about 0.1% to about 2.5% by weight or from about 0.1% to about 1% by weight, and can be a gum, e.g., a gum selected from the group consisting of gum acacia, locust bean gum, arabic gum, and xanthan gum. A lubricant can be present in a range from about 3% to about 15% by weight, or from about 3% to about 10% by weight. Lubricants can be selected from the group consisting of canola, soy, corn, sunflower, safflower, and rapeseed oil.

In another aspect, an edible substrate can further comprise one or more sweeteners or an acidity regulator. Sweeteners are selected from the group consisting of sugar, fructose, sucrose, aspartame, dextrose, dextrose monohydrate, glucose, glucose syrup, icing cane sugar, fondant icing sugar, xylitol, mannitol, monatin, and sorbitol. Sweeteners can be present at from about 0.1% to about 30% by weight, or from about 5% to about 15% by weight. One or more sweeteners can include up to about 10% sugar and up to about 6% dextrose monohydrate.

In another aspect, an edible substrate can further include one or more of the following: a) a second starch component; b) a disintegrant; c) a second thickening agent; d) a colorant; e) water; f) a plasticizer; g) a second emulsifier; h) a humectant; i) a preservative; and i) a flavorant. A second starch component can be present at from about 10% to about 20% by weight, or from about 12% to about 15% by weight. A second starch component can be selected from the group consisting of potato, wheat, tapioca, and maize starch. A disintegrant can be present at from about 1% to about 11% by weight, or from about 1.5% to about 7% by weight. In one embodiment, a disintegrant is microcrystalline cellulose.

A second thickening agent can be present at from about 1% to about 17% by weight, or from about 5% to about 15% by weight. A second thickening agent can be selected from the group consisting of locust bean gum, arabic gum, polysorbate, sodium alginate, xanthan gum, acetic esters of monoglycerides, polyglycerol polyricinoleate, and gum acacia. A plasticizer (e.g., glycerin) can be present at from about 0.1% to about 10% by weight, or from about 2% to about 5% by weight. A second emulsifier can be present at from about 0.1% to about 4.5% by weight, or from about 0.5% to about 1.5% by weight. A second emulsifier can be POLYSORBATE 60. A humectant can be present at from about 0.1% to about 15% by weight, or from about 0.3% to about 10% by weight, and can be selected from the group consisting of glucose syrup, xylitol, and sorbitol, and mixtures thereof. A humectant can be sorbitol at from about 0.2% to about 15% by weight or glucose syrup at from about 0.1% to about 15% by weight, or combinations thereof, wherein the total amount of humectant is from about 0.2% to about 15% by weight.

In another aspect, a method for preparing an edible substrate is provided. The method includes a) heating a fatty phase mixture, the fatty phase mixture including a lubricant and a first emulsifier; b) dispersing the heated fatty phase mixture with a liquid mixture, the liquid mixture comprising water, a first humectant, a plasticizer, a second emulsifier, a flavorant, and a colorant; and c) blending a mixture of dry ingredients, the dry ingredients including a first starch component, a second starch component, a disintegrant, a first thickening agent, a second thickening agent, and a preservative, with the dispersion of step b). The method can further include d) forming a sheet of an edible substrate from the blend of step c). Dry ingredients can further comprise one or more sweeteners and an acidity regulator. The liquid ingredients can further comprise a second humectant, e.g., glucose syrup.

In yet another aspect, a method for preparing an edible transfer tattoo is provided. The method includes a) preparing a sheet of an edible substrate; and b) printing indicia on the sheet of edible substrate. The method can further include cutting and snagging the sheet to facilitate the separation of an edible transfer tattoo from the sheet. The indicia can be printed on the sheet using a silk screen or offset printing process.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is an embodiment of an edible transfer tattoo according to the present invention.

### DETAILED DESCRIPTION

As used herein, all percentages are by weight of a mixture from which an edible substrate is made.

The invention provides edible substrates, edible substrate sheets, edible transfer tattoos, and methods for preparing the same. Edible transfer tattoos can be used to decorate and adorn receptor surfaces, typically skin or comestible products. Edible substrates and edible transfer tattoos including edible substrates are useful to decrease the amount of tattoo carrier material subject to solid waste disposal requirements.

Edible Transfer Tattoos

An edible transfer tattoo generally comprises an edible substrate and an edible ink composition. Edible substrates are adapted for having an edible ink composition printed thereon. Edible substrates can have a thickness ranging from 75 to 1000 micrometers, e.g., from about 100 to about 800 micrometers, from about 100 to about 600 micrometers, or any value therebetween. Edible substrates can have a thickness ranging from 100 to 200, 100 to 300, 100 to 400, 100 to 500, 100 to 600, 200 to 300, 200 to 400, 200 to 500, 200 to 600, 300 to 400, 300 to 500, 300 to 600, 400 to 500, 400 to 600, 500 to 600 micrometers, or any value between such ranges.

An edible ink composition can be any known in the art, including natural or artificial inks, pigments, or colorants and other colorants approved for human consumption, e.g., carmoisine, quinoline, ponceau 4R, blue 1, vegetable carbon, blue V, blue 2, and FD&C pigments such as yellow 5, red 3, red 40, blue 1, and blue 2.

An edible ink composition can be releasably attached to an edible substrate, thereby allowing the edible ink compositions to be transferred to a receptor surface such as skin or a comestible product. An edible ink composition is typically printed on an edible substrate in the form of an image that includes various indicia. Printing can be performed using a number of methods, including a silk screen printing process, an offset printing process, thermal transfer, or ink jetting. An image can include indicia such as words, numbers, symbols (e.g., names or dates); illustrations; cartoons; novelty characters; patterns, decorative art, or other aesthetic images.

Typically an edible transfer tattoo is applied to a receptor surface such as skin by wetting the receptor surface and applying the transfer tattoo to the wetted receptor surface. The edible transfer tattoo is gently rubbed and the edible substrate is removed (e.g., peeled back) to reveal the tattoo applied to the surface. The edible substrate may then be eaten after application of the tattoo. In other circumstances, the edible transfer tattoo itself may be eaten instead of being applied to a surface.

Edible Substrates

Edible substrates useful for preparing an edible transfer tattoo can include a first starch component, a first thickening agent, a lubricant, and a first emulsifier. Additional components can include disintegrants, water, additional starch components, additional thickening agents, additional emulsifiers, colorants (e.g., whitening and/or opacifying agents), preservatives, plasticizers, humectants, sweeteners, acidity regulators, and flavorants. Depending on the total amount of each ingredient and the types of ingredients present in the substrate, a specific component or ingredient can be multi-functional and serve in one or more of the described capacities. For example, in certain embodiments, sorbitol and/or glucose syrup can be used as both a sweetener and as a humectant.

Starch Components

One or more starch components (e.g., first and second starch components) can be used to provide a solid base material or structure-forming material for the edible substrate. A starch can be used in unrefined, refined, unmodified or modified form. Exemplary starches include those based from maize (corn), potato, wheat, and tapioca starch. The total amount of starch components in an edible substrate can be from about 6% by weight to about 26% by weight, or any value therebetween, e.g., 7, 8, 9, 10, 11, 12, 13, 14, 15, 16, 17, 18, 19, 20, 21, 22, 23, 24, 25% by weight. In some embodiments, the total amount of starch components is from about 10% by weight to about 18% by weight, or from about 13% by weight to about 16% by weight. In certain embodiments, a first starch component is a modified starch. A first starch component can be present at from about 0.1% to about 6% by weight, or at from about 0.1% to about 1% by weight. A second starch component can be present at from about 10% to about 20% by weight, or at from about 12% to about 15% by weight. In certain exemplary embodiments, a second starch component is maize starch. Starch components are available commercially from, e.g., Penford Foods, Englewood Colo.

Emulsifiers

An edible substrate can include one or more emulsifers, e.g., a first and/or second emulsifier. An emulsifier can help to ensure homogeneity of an edible substrate and to maintain the clarity of an image applied to an edible substrate. The total amount of emulsifier in a composition can be up to about 10 wt % (e.g., 0.5, 1, 1.5, 2, 2.5, 3, 3.5, 4, 4.5, 5, 5.5, 6, 6.5, 7, 7.5, 8, 8.5, 9, 9.5 weight %). Exemplary substrates can include up to about 5 wt % total emulsifier, and other substrates can include from about 0.3 wt % to about 1.6 wt % (e.g., 0.3, 0.4, 0.5, 0.6, 0.7, 0.8, 0.9, 1.0, 1.1, 1.2, 1.3, 1.4, 1.5%) emulsifier. Suitable emulsifiers include for example, lecithin, polyglycerol polyricinoleate, acetic esters of monoglycerides, polyoxyethylene sorbitan monostearate (e.g. commercially available products such as POLYSORBATE 60, CRILLET, CRILLET VEG A, TWEEN, TWEEN 60), and combinations thereof. A useful emulsifier is a product commercially available under the trade designation POLYSORBATE 60.

A first emulsifier can be present at from about 0.1% to about 3.5% by weight, from about 0.1% to about 2% by weight, or from about 0.1% to about 1% by weight. Certain embodiments include lecithin as a first emulsifier. A second emulsifier can be present at from about 0.1% to about 4.5% by weight, or from about 0.5% to about 1.5% by weight. A second emulsifier can be POLYSORBATE 60 in certain embodiments.

Thickening Agents

An edible substrate can include one or more thickening agents; e.g., first and/or second thickening agents. A thickening agent can be useful in an edible substrate to prevent separation of the ingredients, such as solids from liquids or a fatty phase from an aqueous phase. Including a thickener can also help maintain the viscosity necessary to process an edible substrate. Examples of useful thickening agents for the composition include locust bean gum, arabic gum, acacia gum, polysorbate, sodium alginate, xanthan gum, acetic esters of monoglycerides, and polyglycerol polyricinoleate.

The total amount of thickening agents present can range from about 4% to about 16 wt % (or any value therebetween, e.g., 5, 6, 7, 8, 9, 10, 11, 12, 13, 14, 15% by weight). A first thickening agent can be present at from about 0.1% to about 2.5% by weight, or from about 0.1% to about 1% by weight. In certain embodiments, a first thickening agent is a gum, e.g., a gum selected from the group consisting of gum acacia, locust bean gum, arabic gum, and xanthan gum. One exemplary edible substrate includes xanthan gum as a first thickening agent. A second thickening agent can be present at from about 1% to about 17% (or any value therebetween, e.g., 2, 3, 4, 5, 6, 7, 8, 9, 10, 11, 12, 13, 14, 15, or 16%) by weight, or from about 5% to about 15% by weight. In certain embodiments, gum acacia is used as a second thickening agent. Thickening agents, including gums, are available commercially, e.g., from CNI, Bridgewater, N.J.

Lubricants

Edible substrates can include a lubricant. A lubricant can be a fatty phase, e.g., a fatty phrase comprising an oil. An oil can be any edible oil, and preferably a vegetable oil, such as one derived from, for example, rapeseed, canola, sunflower, safflower, corn, and soy. A combination of oils can also be used. A lubricant can be present in an edible substrate in a total amount of from about 3% to about 15 wt % (or any value therebetween, e.g., 4, 5, 6, 7, 8, 9, 10, 11, 12, 13, or 14%). A lubricant can be present in a total amount of from about 3% to about 10% by weight. In some embodiments, rapeseed oil is used as a lubricant. In other embodiments, canola oil is used.

Disintegrants

Certain edible substrates can include a disintegrant. A disintegrant can facilitate the easy cutting without fraying or fracturing of an edible substrate, and may help maintain the integrity of an image on the substrate. A disintegrant can be present from about 0.1% to about 11 wt %, or any value therebetween, e.g., 1, 2, 3, 4, 5, 6, 7, 8, 9, or 10% by weight. A disintegrant can also be present from about 1.5% to about 7%, e.g., 1.5, 1.7, 1.9, 2, 3, 4, 5, or 6%. A useful disintegrant material is microcrystalline cellulose.

Humectants

A humectant can be present in an edible substrate. Humectants can be used to retain the moisture of an edible substrate and impart flexibility to the substrate. One or more humectants can be included in a total amount from about 5 wt % to about 25 wt % (e.g., 5, 6, 7, 8, 9, 10, 11, 12, 13, 14, 15, 16, 17, 18, 19, 20, 21, 22, 23, 24, or 25%), or from about 5% to about 15%, or from about 8% to about 12%. Useful humectants include, for example, sorbitol, xylitol, and glucose syrup. In some embodiments, sorbitol can be used as a humectant, e.g., in an amount of from about 8% to about 10%. In other embodiments, glucose syrup can be used, e.g., in an amount of from about 8% to about 10%. Other embodiments can include both sorbitol and glucose syrup, e.g., in a total amount of from about 8% to about 12%. It should be noted that certain humectants can be employed as both a humectant and as a sweetener.

Sweeteners

One or more sweeteners can be included in an edible substrate. Suitable sweeteners include, for example, sugar, fructose, sucrose, aspartame, dextrose, dextrose monohydrate, icing cane sugar, glucose, glucose syrup, fondant icing sugar, xylitol, mannitol, monatin, and sorbitol. Certain sweeteners such as sorbitol and glucose syrup have many useful characteristics that impart various features to an edible substrate beyond sweetening, e.g., humectant properties. Dextrose, in the form of dextrose monohydrate, can also be useful, as it can add smooth and cooling taste to the substrate. Typically, one or more sweeteners are added in an amount according to the sweetness profile desired for the edible substrate. In certain embodiments, one or more sweeteners can be in an edible substrate at a total concentration of from about 0.1% to about 30 wt %, or any value therebetween (e.g., 1, 2, 3, 5, 7, 9, 10, 12, 14, 16, 18, 20, 22, 24, 26, 28%); from about 0.1% to about 20%; from about 5% to about 15%; from about 8 wt % to about 22% wt %; or from about 8 wt % to about 15 wt %. In one particular embodiment, an edible substrate can include up to about 10% sugar and up to about 6% dextrose monohydrate by weight. Glucose syrup can optionally be included in the range of about 5% to about 15% by weight. Sorbitol can also be optionally included, e.g., in the range of about 0.1% to about 15%.

Plasticizers

Including a plasticizer in the edible substrate can impart a peelable, flexible characteristic to the substrate. Providing a flexible substrate can also be beneficial in certain image printing techniques, such as off-set printing, where the substrate may need to be manipulated in, for example, axial or radial directions. One example of a useful plasticizer is glycerin. Edible substrates according to the invention can include from 0.1% to about 10 wt % total plasticizer, e.g., about 0.5, 0.8, 1, 2, 3, 3.5, 4, 4.5 5, 5.5, 6, 6.5, 7, 7.5, 8, 9, or 10% plasticizer. In other embodiments, a plasticizer is included in a total amount of from about 2% to about 5% by weight.

Colorants

Edible substrates can include a colorant. As used herein, colorants include color enhancing agents and whitening or opacifying agents. Suitable colorants can be, for example, whiteners, colorants, inks, dyes, or pigments. Certain substrates are often desirably whitened for aesthetic reasons, particularly when used for decorating comestible products such as cakes, cookies, iced biscuits, cupcakes, and the like. A popular whitening or opacifying agent for confectionary applications is titanium dioxide. One or more colorants can be included in a total amount of from about 0.1% to about 4% by weight, e.g., about 0.5, 1, 1.5, 1.8, 2, 2.5, 2.8, 2.9, 3, 3.1, 3.2, 3.5, 3.8% by weight. Any known colorant approved for human consumption can be used, including, for example, carmoisine, quinoline, ponceau 4R, blue 1, vegetable carbon, blue V, blue 2, and FD&C pigments such as yellow 5, red 3, red 40, blue 1, and blue 2. In certain embodiments, about 2.5% to about 3.3 wt % titanium dioxide can be used.

Flavorants

One or more flavorants can be included to impart a desirable taste to an edible substrate. Any flavorants approved for human consumption can be used, including natural and artificial flavorants, such as vanilla, fruit (e.g., lemon, orange, apple, berry, raspberry, blueberry, strawberry, blackberry, kiwi, lime, pear, pumpkin, cherry, mango, papaya, guava), coffee, chocolate, tea, spice (e.g., allspice, cinnamon, nutmeg), nut (e.g., almond, walnut), and herb flavorants. A flavorant can be included from about 0.01% to about 0.5% by weight, or from about 0.1% to about 0.2% by weight.

Preservatives

A preservative can be added to an edible substrate to increase the shelf life of the substrate or edible transfer tattoo and to inhibit microbial growth (e.g. microorganisms including, but not limited to yeast, mold, bacteria). Up to about 1 wt % (e.g., 0.1, 0.2, 0.3., 0.4, 0.5, 0.6, 0.7, 0.8, or 0.9%), or from about 0.1% to about 0.4%, of a preservative can be included. Examples of useful food preservatives include potassium sorbate, sorbic acid, sodium benzoate, EDTA, and combinations thereof.

Acidity Regulators

An edible substrate can include an acidity regulator. One useful acidity regulator is citric acid. An acidity regulator can be included in an amount from about 0.1% to about 1% by weight, e.g., about 0.1, 0.2, 0.3, 0.4, 0.5, 0.6, 0.7, 0.8, or 0.9% by weight.

Water

Water is typically included in an edible substrate in an amount of from about 28% to about 52% by weight, or any value therebetween, e.g., 29, 30, 31, 32, 33, 34, 35, 36, 37, 38, 39, 40, 41, 42, 43, 44, 45, 46, 47, 48, 49, 50, or 51% by weight. Certain embodiments have about 39% to about 42% water.

Edible Substrate Formulations

The invention also provides edible substrate formulations useful for preparing edible substrates, e.g., edible substrate sheets. An edible substrate formulation can include one or more dry ingredients, one or more liquid ingredients, and one or more fatty phase ingredients. Dry ingredients can include thickening agents, sweeteners, acidity regulators, starch components, colorants and/or flavorants, disintegrants, and preservatives described previously. Liquid ingredients can include water, sweeteners, humectants, plasticizers, emulsifiers, and colorants and/or flavorants. Fatty phase ingredients can include emulsifiers and lubricants.

More particularly, in a first general formulation, an edible substrate can comprise, as a percentage by weight of the mixture from which the substrate is made:

a) dry ingredients including: 7% to 17% by wt. gum acacia, 10% to 20% by wt. maize starch, up to 4% by wt. titanium dioxide, up to 6.5% microcrystalline cellulose, up to 2.5% by wt. xanthan, up to 2.7% by wt. modified starch and up to 0.4% potassium sorbate; and

b) liquid ingredients including: 35% to 52% by wt. water, 5% to 15% by wt. sorbitol, up to 10% by wt. glycerine, up to 3.5% by wt. polysorbate 60 and up to 0.2% by wt. vanilla flavouring; and

c) fatty phase ingredients including: 5% to 15% by wt. rapeseed oil and up to 3.5% lecithin.

In a second general formulation, an edible substrate can comprise, as a percentage by weight of the mixture from which the substrate is made:

a) dry ingredients including: 10% to 20% by wt. maize starch, 1% to 11% by wt. microcrystalline cellulose, 1% to 11% by wt. gum acacia, up to 10% by wt. icing cane sugar, up to 6% by wt. modified starch, up to 0.6% by wt. citric acid, up to 1% by wt. xanthan and up to 0.3% by wt. potassium sorbate; and,

b) liquid ingredients including: 28% to 48% by wt. water, 5% to 15% by wt. glucose syrup, 1% to 7% by wt. glycerine, up to 4.5% polysorbate 60, up to 4% by wt. sorbitol and up to 0.2% by wt. vanilla flavouring; and

c) fatty phase ingredients including: up to 10% rapeseed oil and up to 1% by wt. lecithin.

Methods for Preparing Edible Substrates

The invention also provides methods for preparing edible substrates. A typical method includes heating a fatty phase mixture, dispersing the heated fatty phase mixture with a liquid mixture, and blending a mixture of dry ingredients with the dispersion of fatty phase and liquid ingredients. The edible substrate material can then be formed into a variety of shapes, e.g., sheets or rolls.

Dry ingredients for use in the method can include thickening agents, sweeteners, acidity regulators, starch components, colorants and/or flavorants, disintegrants, and preservatives as described previously. Dry ingredients can further comprise one or more sweeteners and an acidity regulator. Liquid ingredients can include water, sweeteners, humectants (e.g., sorbitol), plasticizers, emulsifiers, and colorants and/or flavorants. Liquid ingredients can also comprise a second humectant, e.g., glucose syrup. Fatty phase ingredients can include emulsifiers and lubricants.

In certain embodiments, a method for preparing an edible substrate includes:

a) heating a fatty phase mixture, where the fatty phase mixture comprises a lubricant and a first emulsifier;

b) dispersing the heated fatty phase mixture with a liquid mixture, the liquid mixture comprising water, a first humectant, a plasticizer, a second emulsifier, a flavorant, and a colorant; and

c) blending a mixture of dry ingredients, the dry ingredients comprising a first starch component, a second starch component, a disintegrant, a first thickening agent, a second thickening agent, and a preservative, with the dispersion of step b). Additional steps can include forming a sheet of an edible substrate from the blend of step c).

According to one exemplary embodiment of a method of the invention, an edible substrate can be made by first dry blending all the dry ingredients except the color enhancing agent if used. The liquid ingredients are then blended together into a separate mixture. The optional color enhancing agent is then added to the liquid mixture and dispersed therein using a high shear mixer. This mixing is generally performed for approximately 5 minutes, although the mixing time can be adjusted according to amounts used. The fatty phase ingredients (e.g., lecithin and/or oil) are initially heated to, for example about 70-80° C. and then added to the liquid mixture and dispersed therein using a high shear mixer. Finally, the liquid mixture (with fatty phase) is then added to the blended dry ingredients and mixed for a sufficient time to achieve a well-mixed blend. Mixing time for the final blend can typically take, for example, 5 minutes, although time adjustments can be necessary for larger or smaller volumes of compositions, or for equipment that may have different mixing speeds and capacities.

To form an edible substrate, one or more techniques can be used to provide a substantially planar layer. Suitable techniques include, for example, slot coating or spraying the edible substrate material onto a carrier, or extruding, molding or screen printing. Typically, the layer of material is allowed to solidify to a certain extent, so that further processing can be performed. In an aspect, the formed layer is typically suitable for further processing when it is substantially non-flowable. This ensures that the material does not lose its shape or develop any defects while it is handled in the subsequent processing steps. A substantially non-flowable state generally represents the behavior of a substrate as it is positioned on a substantially horizontal carrier, without being subjected to additional forces (e.g. vacuum or pressure), centrifugal forces or other forces. Although a substantially non-flowable substrate may exhibit some very slow creep, the substrate would not likely move or show deformation unless it was tilted or contacted with an instrument or other object. To achieve a non-flowable state, at least a portion of the water in the composition can be allowed to evaporate or be absorbed by the components in the material. The substrate need not be fully solidified prior to further processing, since the drying/solidification process can continue and progress throughout an entire manufacturing process and possibly into the storage time. In general, a substrate can be handled and manipulated once the material has reached a semi-solid state.

To accelerate the process for achieving a semi-solid or non-flowable state, a substrate can optionally be subjected to heat, such as by the use of ovens, to remove water from the composition. Any type of heat producing equipment is suitable, including, but not limited to, conventional ovens, IR dryers, convection ovens, microwaves, etc. The time and temperature ranges can be adjusted to correspond with a substrate thickness as well as the type and capacity of the heating equipment.

A substrate can be packaged and/or stored until a later time, e.g., for handling and processing in a separate process or facility or by a subsequent manufacturer or printer. Packaging such as bags, envelopes, boxes, and the like can be used to wrap and protect a substrate. Any conventional food packaging material can be used, but particularly useful materials are those that are would not have any deleterious effects on a substrate. Packaging having a good moisture vapor barrier is useful. Exemplary materials that packaging can be made from and are suitable for a substrate according to the invention include for example, polypropylene films, polyester films such as MYLAR® (E.I. du Pont de Nemours and Company; Wilmington, Del.), foils (e.g. aluminum) and the like. A printed or unprinted substrate of the invention can be stored in a freezer or at room temperature. A cool environment can be conducive to maintaining freshness of the substrate.

The substrate can be made in sheet form, roll form, or pre-determined shapes. In any of these formats, the substrate generally takes on a substantially planar dimension. Optionally, the substrate can be trimmed to remove excess, frayed or unusable side trim, or can be cut to a desired size and shape. An edible substrate can be cut and snagged to facilitate the separation of an edible transfer tattoo from the substrate, e.g., the substrate sheet. Typically, a substrate has an average thickness of 75 to 1000 micrometers (μm), or from about 100 to 600 micrometers.

An image can be placed onto a surface of a substrate using any suitable process, such as a silk screen printing process, offset printing, thermal transfer, ink jetting, etc. An image can include, for example, indicia (e.g. dates, names, words, etc); pictures or illustrations; patterns; novelty characters; decorative art; and other aesthetic images. Substrates made according to embodiments of the invention can exhibit ability to hold and maintain the quality and integrity of an applied image. For example, images applied with an edible ink can be placed on certain substrates and maintained such that no significant or undesirable bleeding, fading, refractivity, haziness occurs. An image can be quite clear and aesthetically pleasing when applied onto a whitened substrate, such as those made from compositions according to the invention that include a whitening agent. Substrates with increased opacity can provide clear images, typically when used on food items such as frosted pastries.

An image can be applied in-line, as a substrate is made, just after a substrate reaches its non-flowable state, or at a later stage in a manufacturing process. An image can be made from an edible ink formulation and applied to the substrate in any suitable printing apparatus or process. For example, printing processes that may be used include silk screen, wet offset, lithographic blanket transfer, flexographic Anolux roller transfer, letter press rotary relief plate, web print, reel to reel, and gravure. Suitable printing apparatus include dry offset printers available from Heidelberg Druckmaschinen A G, Heidelberg, Germany, A.B. Dick-Itek Limited, Middlesex, England and Sakurai Machinery, Koto-ku, Tokyo, Japan.

Comestible Products

The invention also provides a composition having a comestible product and indicia from an edible transfer tattoo applied thereto. Numerous types of edible or comestible products can have an edible transfer tattoo applied to them. Items, such as, but not limited to, pastries, iced cakes, ice-cream, candy, vegetables, and meat products are food items that can be decorated, adorned or enhanced by an edible substrate according to the invention.

### EXAMPLES

### Example 1

### Preparation of Edible Substrates Using Two Formulations

Formulation 1

| | % by wt. | Wt. in Kg |
|---|---|---|
| Dry ingredients | | |
| Gum acacia | 14.038 | 6.060 |
| Maize starch | 13.343 | 5.760 |
| Microcrystalline cellulose | 1.946 | 0.840 |
| Xanthan gum | 0.695 | 0.300 |
| Titanium dioxide | 2.896 | 1.250 |
| Modified starch | 0.486 | 0.210 |
| Potassium sorbate | 0.139 | 0.060 |
| Liquid ingredients | | |
| Water | 41.696 | 18.000 |
| Sorbitol | 9.266 | 4.000 |
| Glycerine | 4.633 | 2.000 |
| Polysorbate 60 | 0.973 | 0.420 |
| Vanilla flavouring | 0.116 | 0.050 |
| Fatty phase | | |
| Lecithin | 0.510 | 0.220 |
| Rapeseed Oil | 9.266 | 4.000 |
| Total | 100.00 | 43.170 |

Formulation 2

| | % by wt. | Wt. in Kg |
|---|---|---|
| Dry ingredients | | |
| Maize starch | 14.484 | 6.912 |
| Microcrystalline cellulose | 6.337 | 3.024 |
| Gum acacia | 6.236 | 2.976 |
| Icing cane sugar | 5.029 | 2.400 |
| Dextrose monohydrate | 4.225 | 2.061 |
| Titanium dioxide | 3.152 | 1.504 |
| Modified starch | 0.503 | 0.240 |
| Citric acid | 0.302 | 0.144 |
| Potassium sorbate | 0.084 | 0.040 |
| Xanthan gum | 0.302 | 0.144 |
| Liquid ingredients | | |
| Water | 40.235 | 19.200 |
| Glucose liquid | 9.355 | 4.464 |
| Glycerine | 3.722 | 1.766 |
| Polysorbate 60 | 1.106 | 0.528 |
| Sorbitol | 0.402 | 0.192 |
| Vanilla flavouring | 0.101 | 0.048 |
| Fatty phase | | |
| Rapeseed Oil | 4.023 | 1.920 |
| Lecithin | 0.402 | 0.192 |
| Total | 100.00 | 47.720 |

Edible substrates are prepared from Formulations 1 and 2 as follows:

1. All of the dry ingredients, with the exception of the titanium dioxide, are dry blended together in a mixer;

2. All of the liquid ingredients and the polysorbate 60 are blended together; the titanium dioxide is then added to the liquid blended mixture and dispersed therein using a high shear mixer for approximately 5 minutes;

3. The fatty phase components are heated to between 70 and 80° C., added to the blended liquid phase, and dispersed therein using a high shear mixer; and

4. The blended liquid phase is then added to the blended dry ingredients in the mixer and mixed for 5 minutes or until properly mixed.

### Example 2

### Preparation of an Edible Substrate Sheet and Edible Transfer Tattoo

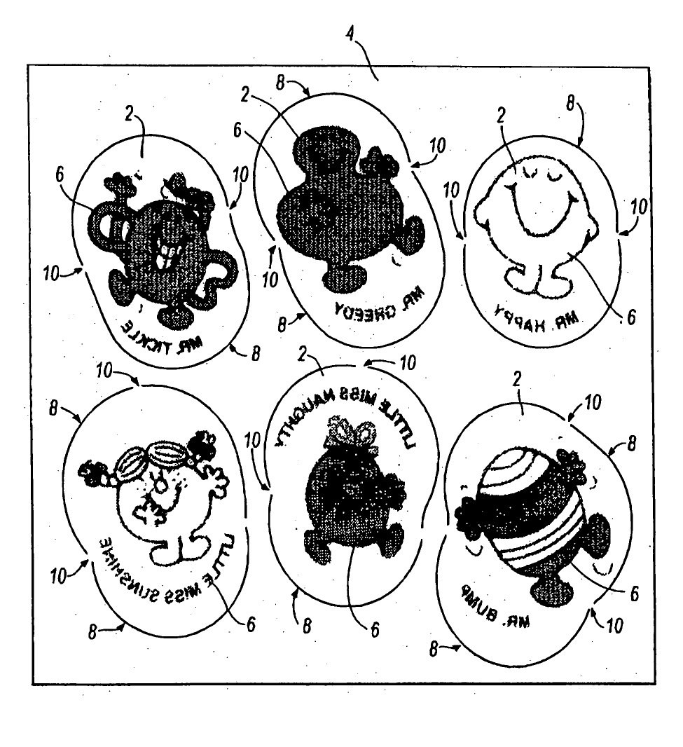

The mixtures described in Example 1 are then formed into a sheet of substrate material of 100 to 600 microns thickness by any suitable process, e.g. by spraying or rolling. Referring to FIG. 1, an edible transfer tattoo 2 provided by the present invention may then be formed as a plurality of such tattoos on a coupon 4 cut from a sheet of edible substrate material. Images 6 are applied to the sheet of edible substrate by a silk screen printing process or an offset printing process. The images 6 are formed using edible inks approved for use with comestible products. The sheet of edible substrate material can then be subjected to the cutting action of a cutting die in a flat bed cutting press. Alternatively, the sheet can be cut using a rotary cutting method. During the cutting operation, each of the images 6 on the sheet of edible substrate material is partially sheared along shear lines 8. At the same time the sheet may be cut up into coupons 5, there being six tattoo images on each coupon 4 as shown in the accompanying drawing. However, during the cutting operation, at least two small areas 10 are left uncut so that the images 6 are retained in the plane of the coupons 4 for packaging and transport to the end user. During the cutting operation the coupons 4 are delineated to be of a size suitable for packaging and sale. The accompanying drawing shows a typical format for the end product in which there are six designs delineated by the shear lines 8, however, smaller or larger coupons may be cut from the sheet as required.

When used, an edible transfer tattoo is removed from the coupon 4 by breaking the uncut areas 10 of the coupon 4. The user then wets the skin where a tattoo is to be applied and places an edible transfer tattoo overlying the wetted area and gently rubs the reverse side of the transfer tattoo before removal thereof to reveal the tattoo applied to the skin. The edible substrate may be eaten after application of the tattoo; indeed, the edible transfer tattoo may be eaten together with the edible ink image. The edible transfer tattoo may also be used for decorating comestible products, e.g. iced biscuits.

A number of embodiments of the invention have been described. Nevertheless, it will be understood that various modifications may be made without departing from the spirit and scope of the invention. Accordingly, other embodiments are within the scope of the following claims.

What is claimed is:

1. An edible substrate comprising:
a) a first starch component;
b) a first emulsifier;
c) a first thickening agent; and
e) a lubricant,
wherein said edible substrate is adapted for having an edible ink composition printed thereon.

2. The edible substrate of claim 1, wherein said first starch component is a modified starch.

3. The edible substrate of claim 1, wherein said first starch component is present at from about 0.1% to about 6% by weight of a mixture from which said edible substrate is prepared.

4. The edible substrate of claim 3, wherein said first starch component is present at from about 0.1% to about 1% by weight of a mixture from which said edible substrate is prepared.

5. The edible substrate of claim 1, wherein said first emulsifier is present at from about 0.1% to about 3.5% by weight of a mixture from which said edible substrate is prepared.

6. The edible substrate of claim 5, wherein said first emulsifier is selected from the group consisting of polysorbate, polysorbate 60, Tween 60, glycerin, polyoxyethylene sorbitan monostearate, crillet, polyglycerol polyricinoleate, acetic esters of monoglycerides, and lecithin.

7. The edible substrate of claim 6, wherein said first emulsifier is lecithin.

8. The edible substrate of claim 5, wherein said first emulsifier is present at from about 0.1% to about 2% by weight of a mixture from which said edible substrate is prepared.

9. The edible substrate of claim 8, wherein said first emulsifier is present at from about 0.1% to about 1% by weight of a mixture from which said edible substrate is prepared.

10. The edible substrate of claim 1, wherein said first thickening agent is present at from about 0.1% to about 2.5% by weight of a mixture from which said edible substrate is prepared.

11. The edible substrate of claim 10, wherein said first thickening agent is a gum.

12. The edible substrate of claim 11, wherein said gum is selected from the group consisting of gum acacia, locust bean gum, arabic gum, and xanthan gum.

13. The edible substrate of claim 12, wherein said gum is xanthan gum.

14. The edible substrate of claim 10, wherein said first thickening agent is present at from about 0.1% to about 1% by weight of a mixture from which said edible substrate is prepared.

15. The edible substrate of claim 1, wherein said lubricant is present in a range from about 3% to about 15% by weight of a mixture from which said edible substrate is prepared.

16. The edible substrate of claim 15, wherein said lubricant is present in a range from about 3% to about 10% by weight of a mixture from which said edible substrate is prepared.

17. The edible substrate of claim 15, wherein said lubricant is selected from the group consisting of canola, soy, corn, sunflower, safflower, and rapeseed oil.

18. The edible substrate of claim 17, wherein said lubricant is rapeseed oil.

19. The edible substrate of claim 1, further comprising one or more sweeteners.

20. The edible substrate of claim 1, further comprising an acidity regulator.

21. The edible substrate of claim 19, wherein said one or more sweeteners are selected from the group consisting of sugar, fructose, sucrose, aspartame, dextrose, dextrose monohydrate, glucose, icing cane sugar, fondant icing sugar, xylitol, mannitol, monatin, and sorbitol.

22. The edible substrate of claim 19, wherein said one or more sweeteners are present at from about 0.1% to about 20% by weight of a mixture from which said edible substrate is prepared.

23. The edible substrate of claim 22, wherein said one or more sweeteners are present at from about 5% to about 15% by weight of a mixture from which said edible substrate is prepared.

24. The edible substrate of claim 19, wherein said one or more sweeteners comprise up to about 10% sugar and up to about 6% dextrose monohydrate, all by weight of a mixture from which said edible substrate is prepared.

25. The edible substrate of claim 20, wherein said acidity regulator is present from about 0.1% to about 1% by weight of a mixture from which said edible substrate is prepared.

26. The edible substrate of claim 25, wherein said acidity regulator is citric acid.

27. The edible substrate of claim 1, further comprising one or more of the following:
a) a second starch component;
b) a disintegrant;
c) a second thickening agent;
d) a colorant;
e) water;
f) a plasticizer;
g) a second emulsifier;
h) a humectant;
i) a preservative; and
i) a flavorant.

28. The edible substrate of claim 27, wherein said second starch component is present at from about 10% to about 20% by weight.

29. The edible substrate of claim 28, wherein said second starch component is present at from about 12% to about 15% by weight.

30. The edible substrate of claim 27, wherein said second starch component is selected from the group consisting of potato, wheat, tapioca, and maize starch.

31. The edible substrate of claim 27, wherein said disintegrant is present at from about 1% to about 11% by weight.

32. The edible substrate of claim 31, wherein said disintegrant is present at from about 1.5% to about 7% by weight.

33. The edible substrate of claim 27, wherein said disintegrant is microcrystalline cellulose.

34. The edible substrate of claim 27, wherein said second thickening agent is present at from about 1% to about 17% by weight.

35. The edible substrate of claim 34, wherein said second thickening agent is present at from about 5% to about 15% by weight.

36. The edible substrate of claim 27, wherein said second thickening agent is selected from the group consisting of locust bean gum, arabic gum, polysorbate, sodium alginate, xanthan gum, acetic esters of monoglycerides, polyglycerol polyricinoleate, and gum acacia.

37. The edible substrate of claim 27, wherein said colorant is present at from about 0.1% to about 4% by weight.

38. The edible substrate of claim 27, wherein said colorant is a whitening agent.

39. The edible substrate of claim 38, wherein said whitening agent is titanium dioxide.

40. The edible substrate of claim 27, wherein said water is present at from about 28% to about 52% by weight.

41. The edible substrate of claim 27, wherein said plasticizer is present at from about 0.1% to about 10% by weight.

42. The edible substrate of claim 41, wherein said plasticizer is present at from about 2% to about 5% by weight.

43. The edible substrate of claim 27, wherein said plasticizer is glycerine.

44. The edible substrate of claim 27, wherein said second emulsifier is present at from about 0.1% to about 4.5% by weight.

45. The edible substrate of claim 44, wherein said second emulsifier is present at from about 0.5% to about 1.5% by weight.

46. The edible substrate of claim 27, wherein said humectant is present at from about 0.1% to about 15% by weight.

47. The edible substrate of claim 46, wherein said humectant is present at from about 0.3% to about 10% by weight.

48. The edible substrate of claim 27, wherein said humectant is selected from the group consisting of glucose syrup, xylitol, and sorbitol, and mixtures thereof.

49. The edible substrate of claim 48, wherein said humectant is sorbitol at from about 0.2% to about 15% by weight or glucose syrup at from about 0.1% to about 15% by weight, or combinations thereof, wherein the total amount of humectant is from about 0.2% to about 15% by weight.

50. The edible substrate of claim 27, wherein said flavorant is present at from about 0.01% to about 0.5% by weight.

51. The edible substrate of claim 50, wherein said flavorant is present at from about 0.1% to about 0.2% by weight.

52. The edible substrate of claim 1, 19, 20, or 27, wherein said edible substrate has a thickness of from about 100 micrometers to about 600 micrometers.

53. An edible transfer tattoo comprising:
a) an edible substrate; and
b) an edible ink composition releasably attached to said edible substrate.

54. A method for preparing an edible substrate sheet comprising:
a) heating a fatty phase mixture, said fatty phase mixture comprising a lubricant and a first emulsifier;
b) dispersing said heated fatty phase mixture with a liquid mixture, said liquid mixture comprising water, a first humectant, a plasticizer, a second emulsifier, a flavorant, and a colorant;
c) blending a mixture of dry ingredients, said dry ingredients comprising a first starch component, a second starch component, a disintegrant, a first thickening agent, a second thickening agent, and a preservative, with said dispersion of step b); and
d) forming a sheet of an edible substrate from said blend of step c).

55. The method of claim 54, wherein said dry ingredients further comprising one or more sweeteners and an acidity regulator.

56. The method of claim 54, wherein said liquid ingredients further comprise a second humectant.

57. The method of claim 56, wherein said second humectant is glucose syrup.

58. A method for preparing an edible transfer tattoo comprising:
a) preparing a sheet of an edible substrate; and
b) printing indicia on said sheet of edible substrate.

59. The method of claim 58, further comprising cutting and snagging said sheet to facilitate the separation of said edible transfer tattoo from said sheet.

60. The method of claim 58, wherein said indicia is printed on said sheet using a silk screen or offset printing process.

61. The method of claim 58, wherein said indicia comprises an edible ink.

62. A composition comprising a comestible product and indicia from an edible transfer tattoo applied thereto.

63. An edible substrate comprising as a percentage by weight of the mixture from which the substrate is made:
i) up to 2.5% by wt. xanthan gum;
ii) 3% to 15% by wt. rapeseed oil;
iii) up to 6% by wt. modified starch; and
iv) up to 3.5% by wt. lecithin.

64. The edible substrate of claim 63, wherein said edible substrate further comprises as a percentage by weight of the mixture from which the substrate is made:
i) 10% to 20% by wt. maize starch;
ii) up to 11% by wt. microcrystalline cellulose;
iii) 1% to 17% by wt. gum acacia;
iv) up to 4% by wt. titanium dioxide;
v) up to 0.4% by wt. potassium phosphate;
vi) 28% to 52% by wt. water;
vii) up to 10% by wt. glycerine;
viii) up to 4.5% by wt. polysorbate 60;
ix) up to 15% by wt. sorbitol; and,
x) up to 0.2% by wt. vanilla flavoring.

65. The edible substrate according to claims 63 or 64, wherein said edible substrate comprises as a percentage by weight of the mixture from which the substrate is made: 14.038% by wt. gum acacia, 13.343% by wt. maize starch, 1.946% by wt. microcrystalline cellulose, 0.695% by wt. xanthan gum, 2.896% by wt. titanium dioxide, 0.486% by wt. modified starch, 0.139% by wt. potassium sorbate, 41.696% by wt. water, 9.266% by wt. sorbitol, 4.633% by wt. glycerine, 0.973% by wt. polysorbate 60, 0.116% by wt. vanilla flavoring, 0.510% wt. lecithin and 9.266% by wt. rapeseed oil.

66. The edible substrate according to claim 63, wherein said edible substrate further comprises as a percentage by weight of the mixture from which the substrate is made:
i) up to 10% by wt. sugar;
ii) up to 5% by wt. dextrose monohydrate;
iii) up to 0.6% by wt. citric acid; and
iv) 5% to 15% by wt. glucose syrup.

67. The edible substrate according to claim 63, 64, or 66, wherein said edible substrate comprises as a percentage by weight of the mixture from which the substrate is made: 14.484% wt. maize starch, 6.337% by wt. microcrystalline cellulose, 6.236% by wt. gum acacia, 5.029% by wt. icing sugar cane, 4.225% by wt. dextrose monohydrate, 3.152% by wt. titanium dioxide, 0.503% by wt. modified starch, 0.302% by wt. citric acid, 0.084% by wt. potassium sorbate, 0.302% by wt. xanthan gum, 40.325% by wt. water, 9.355% by wt. glucose syrup, 3.722% by wt. glycerine, 1.106% polysorbate 60, 0.402% by wt. sorbitol, 0.101% by wt. vanilla flavoring, 4.023% by wt. rapeseed oil and 0.402% by wt. lecithin.

68. A method of manufacture for an edible substrate sheet comprising:
i) blending a dry mixture of ingredients comprising as a percentage by weight of the mixture from which the edible substrate is made:
a) 10% to 20% by wt. maize starch;
b) up to 11% by wt. microcrystalline cellulose;
c) 1% to 17% by wt. gum acacia;
d) up to 6% by wt. modified starch;
e) up to 2.5% by wt. xanthan; and
f) up to 0.4% by wt. potassium sorbate;
ii) blending a liquid mixture of ingredients comprising as a percentage by weight of the mixture from which the edible substrate is made:
a) 28% to 52% by wt. water;
b) up to 10% by wt. glycerine;
c) up to 4.5% by wt. polysorbate 60;
d) up to 15% by wt. sorbitol;
e) up to 0.2% by wt. vanilla flavoring; and,
f) up to 0.4% by wt. titanium dioxide;
iii) heating a fatty phase mixture of ingredients comprising as a percentage by weight of the mixture from which the edible substrate is made;
a) up to 15% by wt. rapeseed oil; and
b) up to 3.5% by wt. lecithin;
iv) dispersing the heated mixture of rape-seed oil and lecithin in the premixed liquid ingredients using a high shear mixer to form an admixture thereof;
v) blending the premixed dry ingredients with the admixed liquid and fatty phase ingredients to form said edible substrate material; and
vi) forming a sheet of said substrate material.

69. The method of claim 68, wherein in said dry ingredients further comprise as a percentage by weight of the mixture from which the edible substrate is made:
i) up to 10% by wt. sugar;
ii) up to 6% by wt. dextrose monohydrate; and
iii) up to 0.6% citric acid.

70. The method of claim 69, wherein said liquid ingredients further comprise 5% to 15% by wt. glucose syrup.

71. The method of claim 68 wherein the blending of the constituents at each stage of the method is effected in a high shear mixer.

72. A method of preparing an edible transfer tattoo comprising:
a) forming a sheet of an edible substrate;
b) printing a design on said sheet; and
c) cutting and snagging said sheet about the design to facilitate the ready removal of the edible transfer tattoo from said sheet.
